(19) United States
(12) Patent Application Publication
(10) Pub. No.: US 2023/0059140 A1
(43) Pub. Date: Feb. 23, 2023

(54) MICROPHONE BACK PANEL AND MICROPHONE

(71) Applicant: AAC ACOUSTIC TECHNOLOGIES (SHENZHEN) CO., LTD., Shenzhen (CN)

(72) Inventors: Scott Lyall Cargill, EB (GB); Euan James Boyd, EB (GB)

(21) Appl. No.: 17/407,194

(22) Filed: Aug. 20, 2021

(51) Int. Cl. H04R 1/08; H04R 1/02

(52) U.S. Cl. CPC H04R 1/08; H04R 1/02

(57) ABSTRACT

A microphone back panel and a microphone are provided. The microphone back panel is used for a microphone, the microphone includes a diaphragm, and the microphone back panel includes a main body. A side of the main body is provided with a thinned area not in contact with the diaphragm, and a hole is formed in the main body. The main body is provided with a thinned area, thereby increasing flexibility of the microphone back panel. When the microphone back panel is bent, the increased flexibility can reduce the stress load on the microphone back panel, thereby reducing possibility of damage to the microphone back panel. In addition, the main body is provided with a hole, thereby further increasing flexibility of the microphone back panel, and reducing stress load on the microphone back panel and reducing possibility of damage to the microphone back panel.

### TECHNICAL FIELD

The present invention relates to the field of acoustic technologies, and in particular, to a microphone back panel and a microphone.

### BACKGROUND

A microphone is an energy conversion device that converts sound signals into electrical signals. Various microphones each include a back panel and a diaphragm. The back panel is a dense layer structure including for example silicon nitride, silicon oxide, and polysilicon, thus stress concentration thereof is relatively serious. When pushing the diaphragm into the back panel by sonic vibration, a crack easily occurs under an action of sound waves due to the stress concentration of the back panel.

### SUMMARY

The present invention provides a microphone back panel and a microphone, aiming to solve the problem in the related art and avoid cracks in the back panel due to stress concentration.

In a first aspect, an embodiment of the present invention provides a microphone back panel for a microphone, the microphone includes a diaphragm, and the microphone back panel includes a main body. A side of the main body is provided with a thinned area not in contact with the diaphragm, and at least one hole is formed in the main body.

As an improvement, the at least one hole includes a plurality of holes.

As an improvement, the plurality of holes are uniformly distributed in the main body.

As an improvement, the plurality of holes are through holes.

As an improvement, the plurality of holes are arranged in a row.

As an improvement, the main body is a solid structure.

As an improvement, the main body is a composite structure of silicon oxide and polysilicon.

In a second aspect, an embodiment of the present invention provides a microphone, including: a microphone back panel including a main body; and a diaphragm arranged at a side of the microphone back panel. A side of the main body is provided with a thinned area not in contact with the diaphragm, and at least one hole is formed in the main body.

For the microphone back panel and the microphone provided by the embodiments of the present invention, the main body is provided with a thinned area, thereby increasing flexibility of the microphone back panel. In this case, when the microphone back panel is bent, the increased flexibility reduces the stress load on the microphone back panel, thereby reducing possibility of damage to the microphone back panel. In addition, for the microphone provided by embodiments of the present invention, the main body is further provided with at least one hole, thereby further increasing the flexibility of the microphone back panel, and thus reducing the stress load on the microphone back panel and reducing possibility of damage to the microphone back panel.

It should be understood that the foregoing general description and the following detailed description are merely exemplary and are not intended to limit the present invention.

### BRIEF DESCRIPTION OF DRAWINGS

In order to more clearly illustrate technical solutions in embodiments of the present invention or in the related art, the accompanying drawings used in the embodiments and in the related art are briefly introduced as follows. It should be noted that the drawings described as follows are merely part of the embodiments of the present invention, and other drawings can also be acquired by those skilled in the art without paying creative efforts.

FIG. 1 is a schematic diagram of a structure of a microphone back panel provided by an embodiment of the present invention;

FIG. 2 is a schematic diagram of a structure of a portion of the microphone back panel shown in FIG. 1;

FIG. 3 is cross-sectional view along A-A of a portion of the microphone back panel shown in FIG. 1;

FIG. 4 is an enlarged view of a portion of the microphone back panel shown in FIG. 3; and

FIG. 5 is a front view of a structure of a back panel without a thinned area.

### REFERENCE SIGNS

1—main body

11—thinned area; and

12—hole.

The drawings herein are incorporated into and constitute a part of the present specification, illustrate embodiments of the present invention and explain principles of the present invention together with the specification.

### DESCRIPTION OF EMBODIMENTS

The technical solutions in the embodiments of the present invention are described in the following with reference to the accompanying drawings. It should be noted that, the described embodiments are merely exemplary embodiments of the present invention, which shall not be interpreted as providing limitations to the present invention. All other embodiments obtained by those skilled in the art without creative efforts according to the embodiments of the present invention are within the scope of the present invention.

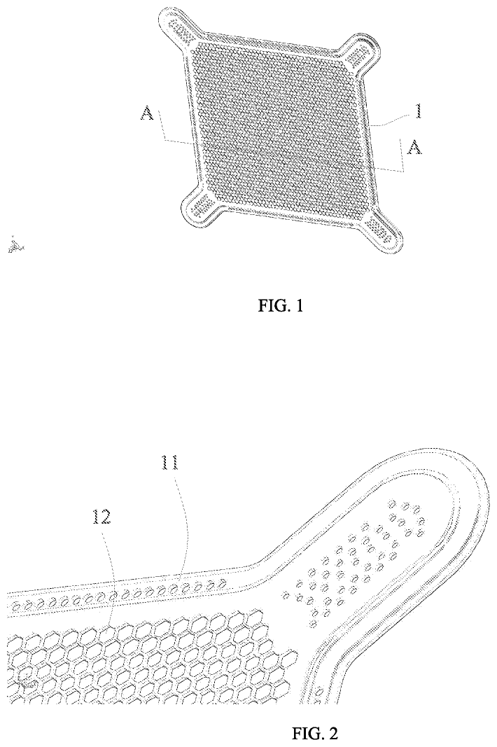

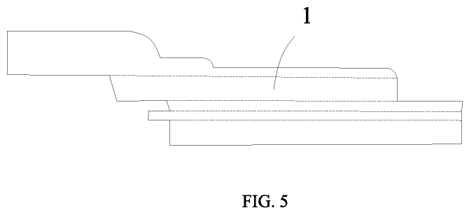

As shown in FIG. 1 to FIG. 5, an embodiment of the present invention provides a microphone back panel for a microphone, and the microphone further includes a diaphragm. The microphone back panel includes a main body 1, and a side of the main body 1 is provided with a thinned area 11, and the thinned area 11 is an area not in contact with the diaphragm. At least one hole 12 is formed in the main body 1.

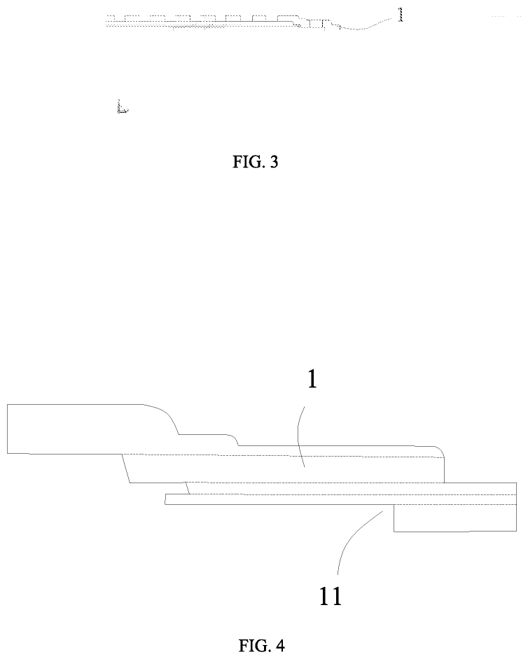

FIG. 5 is a front view of a structure of a back panel without a thinned area. From the perspective of FIG. 3, a portion of a bottom of the main body 1 is removed to form the thinned area 11 as shown in FIG. 2. This portion of the bottom of the main body 1 does not contact the diaphragm, and the thinned area 11 where this portion of the bottom of the main body 1 is removed does not contact the diaphragm.

For the microphone back panel provided by this embodiment of the present invention, the main body 1 is provided with a thinned area 11, thereby increasing flexibility of the microphone back panel. In this case, while bending the microphone back panel, the increased flexibility reduces the stress load on the microphone back panel, thereby reducing possibility of damage to the microphone back panel. In addition, for the microphone back panel provided by this embodiment of the present invention, the main body 1 is further provided with at least one hole 12, thereby further increasing the flexibility of the microphone back panel, and thus reducing the stress load on the microphone back panel and reducing possibility of damage to the microphone back panel.

As shown in FIG. 2, the thinned area 11 may be provided at a circumferential edge of the main body 1, and the above-mentioned hole 12 may be provided in the edge of the main body 1 and most portions of the main body 1.

In an embodiment, the at least one hole 12 described above includes a plurality of holes 12, thereby increasing the flexibility of the microphone back panel.

In an embodiment, the plurality of holes 12 are uniformly distributed in the main body 1, so that a bending force subjected by each position when the microphone back panel is bent is more uniform.

In an embodiment, the hole 12 is implemented as a through hole, thereby increasing the flexibility of the microphone back panel.

In an embodiment, the plurality of holes 12 described above are arranged in a row.

In an embodiment, the main body 1 described above is a solid structure.

In an embodiment, the main body 1 is a composite structure of silicon oxide and polysilicon.

An embodiment of the present invention further provides a microphone, including a microphone back panel and a diaphragm arranged on a side of the microphone back panel. The microphone back panel is a microphone back panel provided by any embodiment of the present invention, and the microphone back panel includes a main body 1, and a side of the main body 1 is provided with a thinned area 11. The thinned area 11 is an area not in contact with the diaphragm. At least one hole 12 is formed in the main body 1.

For the microphone provided by this embodiment of the present invention, the main body 1 is provided with a thinned area 11, thereby increasing flexibility of the microphone back panel. In this case, while the microphone back panel is bent, the increased flexibility reduces the stress load on the microphone back panel, thereby reducing possibility of damage to the microphone back panel. In addition, for the microphone provided by this embodiment of the present invention, the main body 1 is further provided with at least one hole 12, thereby further increasing the flexibility of the microphone back panel, and thus reducing the stress load on the microphone back panel and reducing possibility of damage to the microphone back panel.

The above-described embodiments are merely exemplary embodiments of the present invention and are not intended to limit the present invention. Any modifications, equivalent substitutions and improvements made within the principle of the present invention shall fall into the protection scope of the present invention.

What is claimed is:

1. A microphone back panel for a microphone, the microphone comprising a diaphragm, and the microphone back panel comprising a main body,
wherein a side of the main body is provided with a thinned area not in contact with the diaphragm, and at least one hole is formed in the main body.

2. The microphone back panel as described in claim 1, wherein the at least one hole comprises a plurality of holes.

3. The microphone back panel as described in claim 2, wherein the plurality of holes are uniformly distributed in the main body.

4. The microphone back panel as described in claim 2, wherein the plurality of holes are through holes.

5. The microphone back panel as described in claim 2, wherein the plurality of holes are arranged in a row.

6. The microphone back panel as described in claim 1, wherein the main body is a solid structure.

7. The microphone back panel as described in claim 1, wherein the main body is a composite structure of silicon oxide and polysilicon.

8. A microphone, comprising:
a microphone back panel comprising a main body; and
a diaphragm arranged at a side of the microphone back panel, wherein a side of the main body is provided with a thinned area not in contact with the diaphragm, and at least one hole is formed in the main body.

9. The microphone as described in claim 8, wherein the at least one hole comprises a plurality of holes.

10. The microphone back panel as described in claim 9, wherein the plurality of holes are uniformly distributed in the main body.

11. The microphone back panel as described in claim 9, wherein the plurality of holes are through holes.

12. The microphone back panel as described in claim 9, wherein the plurality of holes are arranged in a row.

13. The microphone back panel as described in claim 8, wherein the main body is a solid structure.

14. The microphone back panel as described in claim 8, wherein the main body is a composite structure of silicon oxide and polysilicon.
